(19) United States
(12) Patent Application Publication
(10) Pub. No.: US 2025/0345967 A1
(43) Pub. Date: Nov. 13, 2025

(54) Extruder for Producing Gypsum Moulded Articles, Process for Manufacturing Gypsum-Based Articles and Gypsum-Based Articles

(71) Applicant: Knauf Gips KG, Iphofen (DE)

(72) Inventors: Rauno Baese, Iphofen (DE); Raphael Geiger, Iphofen (DE)

(21) Appl. No.: 18/871,691

(22) PCT Filed: Jun. 7, 2023
(86) PCT No.: PCT/EP2023/025272

§ 371 Date: Dec. 4, 2024

(30) Foreign Application Priority Data
Jun. 8, 2022 (EP) 22000152.3

(51) Int. Cl. B28B 17/02; B28B 3/20; B28B 3/22; E04B 9/04

(52) U.S. Cl. CPC B28B 17/023; B28B 3/201; B28B 3/226; E04B 9/04

(57) ABSTRACT

An extruder, preferably for calcining and extruding raw gypsum, including a calcination zone and a mixing zone, wherein the extruder is optionally configured to capture and/or retain water liberated in the calcination zone, apparatuses and processes employing such extruders and respective uses.

### CROSS-REFERENCE TO RELATED APPLICATIONS

This application is the United States national phase of International Application No. PCT/EP2023/025272, filed Jun. 7, 2023, and claims priority to European Patent Application No. 22000152.3 filed Jun. 8, 2022, the disclosures of which are hereby incorporated by reference in their entireties.

### BACKGROUND OF THE INVENTION

### Field of the Invention

The present invention lies in the field of dry construction and relates, inter alia, to an extruder having a calcination zone and a mixing zone.

In the construction of buildings, one of the most common building elements are gypsum panels, which are also known as gypsum panelling, gypsum building panels, gypsum boards, gypsum plasterboard, or wallboard, which are primarily used in the construction of walls and/or ceilings. Such gypsum panels are made by reacting water and calcium sulphate hemihydrate such that the calcium sulphate hemihydrate sets to form calcium sulphate dihydrate (gypsum). The calcium sulphate hemihydrate is obtained by calcining gypsum, and it is typically comprised primarily of calcium sulphate hemihydrate but can also contain calcium sulphate anhydrite in varying amounts. The calcium sulphate hemihydrate is produced by calcination of calcium sulphate dihydrate to partially dehydrate the calcium sulphate dihydrate.

Up until now, in the manufacturing of gypsum-based construction materials, such as for example gypsum panels, raw gypsum is calcined in the run-up to the actual manufacturing process and converted to the hemihydrate (bassanite). Bassanite reacts upon addition of water and then builds up solidities. For the manufacturing of gypsum, a mixture of bassanite and water (and additional ingredients/additives) are mixed via a mixing device and formed into forms or used as a pulp at a conveyor line for the manufacturing of gypsum panels or gypsum boards. Often, significantly more water is used than would be necessary for the chemical reaction itself. Furthermore, the processing/treatment of the raw gypsum, and thus also the calcination, is consuming a lot of energy and requires a lot of space.

### Description of Related Art

As prior art documents that may be of background interest the following might be named: In CN 103043621 B and CN 203128194 U the use of two consecutive extruders to first convert gypsum to hemihydrate and anhydrite and then decompose the anhydrite to CaO, SO₂ and O₂ is described. In WO 2017/135250 A1 the treatment of calcined gypsum with water is described. EP 1 051 880 B1 discloses a heatable worm conveyor and WO 2010/014952 A2 discloses a mixer/extruder for low pressure applications and ribbon blenders in the production of tablets.

### SUMMARY OF THE INVENTION

It is an object of the present invention to overcome the problems associated with the prior art. Particularly, the processes of the prior art should be simplified and resources be saved. Additionally, the manufacturing apparatuses/plants should be reduced in size and energy consumption.

These objects, and other objects that present themselves to the person skilled in the art upon regarding the present description and claims, are solved by the subject matter outlined in the independent claims.

Particularly well-suited embodiments are given in the dependent claims as well as the following description:

In the present invention the term “dihydrate” (also named “calcium sulphate dihydrate”) relates to CaSO₄*2H₂O.

The term “raw gypsum” is directed to gypsum having CaSO₄*2H₂O as main ingredient, regardless of its origin, so that it also encompasses mineral CaSO₄*2H₂O, waste gypsum materials, e. g. from recycled gypsum panels or plasters, REA-gypsum (“Rauchgasentschwefelungsanlagen-Gips”, also called FGD-gypsum) and the like, as long as the main ingredient is CaSO₄*2H₂O. Recycled gypsum is gypsum, which is derived from e.g. a previous construction application, (e.g. as plaster board) and thus in most cases will contain quantities, preferably minor quantities of components which are not found in raw gypsum. Such components include e.g. inorganic constituents, such as fractions from deconstructed building sites comprising concrete, bricks or similar materials and/or organic constituents, such as residues or (cellulose) fibres from card- or paperboard or surfactants, which have been used in a plasterboard to create air voids for lightweight construction. FGD-gypsum is gypsum from flue-gas desulfurization, so that such gypsum will usually not contain either of relevant quantities of other minerals or residues of organic constituents.

However, the term “main ingredient of raw gypsum” in the context of the present application can also mean that the “raw gypsum” contains at least 30 wt.-%, preferably 50 wt.-%, more preferably 80 wt.-%, even more preferably at least 85 wt.-%, still even more preferably at least 90 wt.-%, and most preferably at least 95 wt.-% of calcium sulphate dihydrate.

The term “gypsum” or “gypsum material” relates to CaSO₄ independent of its hydration state and encompasses the dihydrate, the hemihydrate and mixtures of various hydration states, the exact meaning is readily apparent to the person skilled in the art from the respective context. In the present invention the terms “calcium sulphate hemihydrate”, “hemihydrate”, “bassanite” and “plaster” relate to CaSO₄*0.5H₂O. In the present invention the term “anhydrite” relates to CaSO₄ (i.e., without crystal water, including e. g. anhydrite II and anhydrite III).

In the present invention the term “raw gypsum” relates to naturally occurring gypsum or synthetic gypsum that has not already been processed. Also, the term “raw gypsum” may relate to waste gypsum materials that have not already been processed.

The raw gypsum in the present invention can be used as a paste (e.g. with water, which means either dug from the ground and therefore earth-moist or formed from e. g. recycling gypsum and water to thereby e. g. reduce dusting and increase flow properties), a powder or a granulate or any other convenient form which is known by the skilled person.

In the present invention unless otherwise stated temperature are in degrees Celsius and reactions and process steps are conducted under atmospheric pressure, i.e. about 1013 kPa. In the present invention, unless otherwise stated, pressures given are absolute pressures (i.e. not gauge). In the present invention usually are given as SI Units, where S designated seconds, Min designates Minutes and Hrs designated hours.

Summarising, according to the present invention, a paste, granulate or powder of ground raw gypsum is fed into an extruder, and this raw gypsum is then converted (calcined) into bassanite by means of a heated screw and/or a heated extruder barrel as well as the frictional energy during extrusion. The liberated water in preferred embodiments remains in the system (closed system/circuit) and can then be used on the one hand for rheology adjustment and on the other hand as water for the setting reaction (of the hemihydrate produced in the first (heating) part of the extruder/extrusion). Thus, it becomes possible to reduce the number of apparatuses in a plant with respect to the calcining unit and additionally the amount of water necessary is reduced. The use of additional water as well as additives and auxiliaries is, however, still possible. In the case of water, however, significantly less needs to be added. In especially preferred embodiments, only the water that is liberated during the calcination step in the calcination zone of the extruder is used. In these embodiments, the raw gypsum supplies exactly the proportion of water needed to set the bassanite. In general, it is preferred to add an amount of less than 40 wt-% of water relative to the fed raw gypsum, more preferred an amount of less than 35 wt-% of water relative to the fed raw gypsum, even more preferred an amount of less than 30 wt-% of water relative to the fed raw gypsum,

The process of the present invention thus combines two process steps, namely the calcination and extrusion of the settable gypsum pulp, in one and uses the process energy of the extrusion sensibly for calcining the gypsum. However, mixing of the gypsum material always takes place. Significant energy saving potentials (and CO₂ equivalents) compared to the status quo in the production result from the at least partial, preferably complete omission of a drying step of the calcined calcium sulphate, as well as from significantly lower drying energies in production, due to the reduced amount of water in the setting process. Therefore, by the present invention, it becomes possible to build gypsum panel plants requiring significantly less space. Also, a more flexible and faster controllability of the temperature, to which the raw gypsum is subjected while passing through the extruder.

Due to increased temperatures and pressures in at least parts of the extruder, according to the invention, the extruder is run with ground raw gypsum without calcining it first. Through pressure and/or temperature, the calcination is carried out in the extruder itself. Under such conditions, it becomes possible to have hemihydrate and water together in a stable state next to each other. These conditions can be maintained until shortly before extrusion to prevent setting. Optionally, a retarder can also be used. The water required for the setting reaction is already present in sufficient quantity in the raw gypsum (stoichiometric water) and can be run through the entire process (closed water circuit) in preferred embodiments. A further addition of water, liquefiers or similar auxiliary materials is also possible in order to influence rheological properties or to favour heat transport in the material. Also, the final product properties can be influenced in that way. Overall, however, it becomes possible to save significant quantities of water. The gypsum panel or the gypsum moulded article can be produced in the context of the present invention directly after grinding the raw gypsum, thus plants can be more compact and process energies can be saved.

According to the present invention, an extruder is employed, while in certain embodiments of the present invention the temperature can also be adjusted via screw pitches according to the required temperatures.

One (alternative) process according to the present invention comprises the use of an extruder that is not (at least partly) heated or heatable itself and the step of providing the required heating for the calcination of the raw gypsum only by the pitch and the action of the extruder screws. However, cooling might be possible in such a process.

According to embodiments of the present invention, the extruder is heated directly at the beginning of the screw (i.e. the calcination zone, in order to calcine the raw gypsum) and at the end of the extrusion screw run at a lower temperature for immediate setting of the gypsum pulp after extrusion (i.e. after it exits the extruder according to the present invention). Therefore, in preferred embodiments of the present invention it may be possible to cool down the extruder towards the end of the extrusion screw.

The present invention is also specifically directed to an extruder, preferably for calcining and extruding, in particular configured for calcining and extruding raw gypsum, comprising at least the following elements, which are given here in the direction of the substance flow:
A) (material) inlet, preferably inlet for raw (already ground) gypsum, either in pulverulent form or as a paste (e.g. with water, inter alia to reduce dusting and increase flow properties);
B) downstream of that an extruding zone comprising at least one extruder screw and comprising
   B1) a calcination zone;
   B2) (downstream of the calcination zone) a mixing zone;
      the extruding zone comprising at least one temperature setting device selected from
   a) at least one entirely or partly temperature settable extruder screw (in some embodiments preferred), and/or
   b) one or more temperature setting devices each setting the temperature in at least a part of the extruder barrel;
   c) optionally, other internal or external temperature setting devices;
C) (downstream of the extruding zone) an outlet zone or device, in particular an orifice,
   wherein the extruder is preferably configured to capture and/or retain water liberated in the calcination zone and optionally to deliver this water into the mixing zone.

The inlet A) may comprise a sizing unit in order to size (or grind) the raw gypsum before it enters the actual extruder and the calcining zone of it. In general, the particles of the raw gypsum should have a particle size, which is small enough that a uniform temperature distribution and heating of the raw gypsum is possible. By sizing the raw gypsum prior to the calcining step the particle sizes can be adapted to better suit the dimension of the extruder, e.g. of the extruder screw(s) and/or the inside of the extruder barrel, or the particle sizes can be adapted to the desired energy intake for heating (it is known to the person skilled in the art that differently sized particles have different properties when it comes to heating and conducting the heat to the inside). For calcination it is preferred that the particle size of the gypsum is higher than indicated for the calcined gypsum above, such as e.g. in the range of 0.1 to 5 mm and in particular in the range 0.2 to 3 mm. Such particle size can be determined by sieving analysis.

In the context of the present invention, sizing, in particular crushing or grinding, of the raw gypsum, if necessary or desired, may be carried out by methods known in the art, for example, the incoming material may be reduced in size using a shredder; crusher; bucket crusher; excavator with grapple; or simply driven over with a front end loader. In principle, any sizing, in particular crushing or grinding, equipment may be used and the person skilled in the art will be able to vary parameters of the mechanical sizing equipment to determine the proper speed, force, and time to generate gypsum particles having the desired particle size.

The sizing unit, if present, may be integral to the extruder inlet or it may be attached to the beginning of the inlet.

Depending on the configuration of the extruder, the extruder can also tolerate larger particle size, which may be processed to smaller particle sizes inside the extruder, such as by processing via grinding elements. Thus, in principle, it is possible that the extruder can be operated directly at a mining size.

Also, the raw gypsum may be heated gently before entering the extruder, of course without calcining the gypsum already. E. g. a temperature of between 30° C. to 40° C. may preferably be desired for the raw gypsum before entering the extruder. However, more than 80° C. may not be desired before entering the extruder.

The mixing zone can be integral with the downstream end of the calcination zone, i.e. with no separation means between the two zones, in embodiments of the present invention. In these cases, the borders of the two zones are not clearly drawn and the zones gradually merge into one another. Optionally, the mixing zone is integral with the downstream end of the calcination zone.

However, in other embodiments, the two zones can also be clearly distinguished from one another such that between them a wall or the like is inserted in the extruder. Then only an aperture for each extruder screw is left, optionally with a little space around it for the material. In such embodiments, a seal may be provided at each aperture so that the two zones are more thoroughly separated from each other.

If no clear borders are inserted between the zones, then they may be given by the process that occurs within them. Usually, in the calcination zone the temperature is raised, i.e. the extruder is heated, and liberated crystal water is collected but (apart from the raw gypsum entering this zone) no material is added. On the other hand, in the mixing zone water and optionally additives and auxiliaries is/are added to the calcined calcium sulphate, but this zone is not necessarily heated, or if so, only to a lesser degree (lower temperature) than the calcining zone. Also cooling of the mixing zone is possible for faster setting of the extrudate. The expression “exdrudate” generally means in the context of the present invention the material inside the extruder as well as exiting the extruder.

In some preferred embodiments the extruder (especially calcination zone and the mixing zone) are built up from singular elements (extruder elements), these single elements can include each a temperature setting device. In this way, the extruder can be built up easily depending on the length needed with several temperature setting devices.

In some embodiments the size of the zones (their length along the extruder screw(s)) are variable in that the part of the extruder that is heated (or cooled) can be varied (by adaptable size of the temperature setting elements) and that various devices for water (and additive/auxiliary) supply are present, that can be used as needed. For example, if the calcination zone should be larger (longer), then temperature setting devices further downstream can be engaged and the first supply device(s) may be turned off and only later (downstream-wise) supply devices used.

Therefore, in embodiments of the invention, the temperature setting devices can be of different sizes and can be activated and/or controlled independently from each other.

Thus, in a simple embodiment only two temperature setting devices, one for each zone, are present and the calcination zone the temperature can be set to a certain temperature while the mixing zone the temperature can be set only to a lower temperature.

However, in other embodiments, there are a plurality of temperature setting elements provided. The more elements are provided, the more options for specific (e.g. targeted) temperature setting are given.

In another embodiment in both zones several temperature setting devices are present, e. g. everywhere in the two zones apart from the first part (first element) which includes the inlet. This has the advantage to be able to precisely control the temperature in the extruder and/or to control the process, which may be adjusted to the specific raw gypsum.

It is understood according to the present invention, that the temperature setting elements or devices in some cases may be either heating elements or cooling elements (or devices). This may be due to the fact that the technical design of heating or cooling devices in simple cases may be different. For example, cooling may be done either via cooling fans or in cooling channels incorporated in the screw barrel. These may contain a cooling medium. This can be water under pressure, for example. However, also temperature setting elements or devices being able to set temperatures between e. g. 5° C. and 350° C., preferably 5° C. and 280° C. are conceivable. However, in some embodiments, besides heating also cooling may be necessary in the same parts of the extruder, simply for regulating the temperature as exact as possible.

In one embodiment of the present invention, it is preferred that the temperature setting elements or devices that are cooling elements or devices are located in the extrusion zone, preferably towards the outlet zone. Such cooling elements or devices may be each independently configured to cool the extrudate in the mixing zone to, and optionally keep at, temperatures of between 5° C. and 120° C., preferably 5° C. to 80° C., more preferably between 10° C. to 45° C., even more preferably between 15° C. and 40° C.

In one embodiment of the present invention, it is preferred that the extruder screw(s) is or are partly or entirely heatable. This has the advantage, that the extrudate is heated from the centre (literally only when single screw extruder is used) of the extruder and thus heated material is distributed.

In another embodiment, still other internal or external temperature setting devices are provided, for example fans, cooling channels, microwave generators or infrared lamps.

In addition to the setting of the temperature via the temperature setting devices as above, in some embodiments the screws are configured such that a further heating is achieved via the inclination of the screws. In variants of this embodiments the screws, or segments of them, may be of variable inclination and the inclination can be adapted prior and/or during the extrusion process.

Additionally, it is within the scope of the present invention, that with the length of the extruder screw(s) the heating or cooling duration and dwell time (also called residence time) can be influenced.

The residence time of the raw gypsum in the extruder is the time from the introduction of the raw gypsum into the extruder until the extrudate is discharged from the extruder. The residence time has e. g. a relevant impact on the conversion of the calcium sulphate dihydrate to hemihydrate, as the longer the calcium sulphate dihydrate is subjected to the elevated temperatures, the more of the dihydrate will be converted to hemihydrate. On the other hand, if the residence time is too long, the risk of overburning and the production of larger amounts of anhydrite increases. In general, various residence times are possible, depending on the other parameters like screw design, amount of the fed material, grinding degree of the fed material, energy input and/or rotational speed. To ensure an advantageous compromise between these effects, the residence time and thus the calcination time can preferably adjusted to be rather short, and thus the calcination very fast, in the range of 10 s to 5 min, preferred in the range of 10 s to 2 min, more preferred in the range of 10 s to 1 min. Further, long residence times up to 3 hrs are possible, also. This could result in less energy consumption and/or a more precise control of the process. However, the residence time is also dependent on the heat transfer within the extruder. Of course, the residence time has also impact on the sufficiency of the conversion of hemihydrate back to calcium sulphate dihydrate.

Further, the skilled practitioner will appreciate that a higher feed rate will reduce the residence time of the gypsum material at the temperature in the extruder, where the calcium sulphate dihydrate in converted to hemihydrate. For the inventive process, it has been found that a raw gypsum feed rate into the extruder, which is at least 1.5 to 6 kg/(h×EV), wherein EV is the empty volume of the extruder in L (liter), provides favorable results in terms of a high content of calcium sulphate hemihydrate at low residues of dihydrate and little overburning to anhydrite. The empty volume (EV) may be e. g. 0.38 L, preferably for trials. However, for industrial production also much higher EV are possible. If the EV is much higher, distance between the inside wall of the extruder and the screw can be higher, too. However, in this case it is preferred for the energy transfer from/to the raw gypsum to have a similar distance between the inside wall of the extruder and the screw (compared to smaller EVs), which can be e. g. between 2 and 9 mm and/or using the temperature setting devices in the extruder element and/or the screw(s). In general, the filling rate of the extruder can vary. However, a filling rate of 100% is not preferred and/or a filling rate of more than 10% is desired, also for energy consumption reasons.

In embodiments of the present invention, the extruder is configured to be sealed to the outside, such that no liberated water escapes the extruder. In this way, the water liberated from the raw gypsum during calcining is retained and can entirely be used in the mixing step in order to form a settable gypsum pulp. This does not exclude the addition of further water, if desired or necessary, to get a gypsum pulp with the desired properties.

In further embodiments of the present invention at least the calcination, and optionally also the mixing step, are performed under elevated pressure, so that under the chosen temperature and pressure both calcium sulphate hemihydrate and water are stably present beside each other. In these embodiments, the extruder is preferably configured to be gastight. If only the calcination is to be performed under elevated pressure, but not the mixing with water (and additives/auxiliaries), then the calcining zone and the mixing zone are separated from each other, for example as outlined above.

The conditions required for such process conditions can be derived from for example J. Chem. Phys. 128, 074502 (2008), FIG. 1, or other publications like this. In this figure, it is shown that the process of calcination is dependent on temperature and pressure. More detailed, it indicates the influence of temperature is more relevant than pressure in regard to the calcination of gypsum.

If the calcining zone and the mixing zone are pressure-sealed against each other, this sealing is in some embodiments achieved by guiding the extruder screw or screws through a hole or holes inside a wall between the regions wherein the hole or holes has/have a seal/seals around each extruder screw.

The outlet zone or device can in embodiments be in the form of an orifice, preferably also equipped with a knife to cut the extrudate in pieces of the desired length.

Additionally, in some embodiments, the extruder according to the present invention comprises at least one of the following additional devices:
at least one device for supplying water or aqueous mixtures into the mixing zone and/or the calcining zone, which can be of any kind known in the art, in particular a simple inlet port like a nozzle,
at least one device for discharging water or aqueous mixtures from the mixing zone and/or the calcining zone, which can be of any kind known in the art, in particular a simple outlet port like a funnel,
at least one device for supplying solid additives into the mixing zone, which can be of any kind known in the art, in particular a simple inlet port like a nozzle
at least one device for supplying water or aqueous mixtures into the inlet A), which can be of any kind known in the art, in particular a simple inlet port like a nozzle,
one or more degassing units to remove the crystal water from the extruder, which is detached from the calcium sulphate dihydrate or water which may have been introduced into the extruder as part of a paste (The position of these units can be arranged by extruder elements containing chimneys to degas, evaporate or insert gas),
at least one device for supplying solid additives into the inlet A), which can be of any kind known in the art, in particular a simple inlet port like a nozzle.

Of course, in further embodiments the extruder may comprise also further devices for supplying or discharging compounds to or from the calcining zone. These are usually not necessary, though.

As outlined above, in certain embodiments, the extruder according to the present invention can have different pressure zones and
optionally comprise a device for increasing or decreasing the pressure inside the extruder, such as a pump connected to the inside of the extruder, and/or
optionally an overpressure-releasing device, in particular an overpressure-valve.

This means that not only atmospheric pressure, but also elevated pressure as well vacuum are possible here. This may be useful e. g. for the production of alpha-hemihydrate.

In some embodiments of the present invention, the temperature setting devices are configured such that they are able to heat and/or cool the calcination zone and the mixing zone of the extruder independently from one another.

Thus, in preferred embodiments,
in the calcining zone the temperatures can be raised such that from the raw gypsum, i.e. calcium sulphate dihydrate, crystal water is liberated and hemihydrate or anhydrite forms of calcium sulphate are formed, and
in the mixing zone the temperatures can be controlled, e. g. lowered, such that the mixing of the hemihydrate (optionally including also anhydrite to a certain amount) with water and optionally additives or auxiliaries to form a settable gypsum pulp is possible.

In more specific embodiments of the former embodiments, the extruder according to the present invention is configured such that the temperature setting devices are each independently configured to heat the extruder or at least parts of the extruder, and particularly, the extrudate depending on its position in the extruder to, and optionally keep, at temperatures of between 5° C. and 350° C., preferably 5° C. and 280° C., more preferably between 10° C. and 200° C., even more preferably between 15° C. and 180° C.; in particular
to set the temperature of the extrudate in the calcination zone to, and optionally keep at, temperatures of between 5° C. and 350° C., preferably 40° C. and 280° C., more preferably between 45° C. and 200° C., even more preferably between 80° C. and 180° C., and
to set the temperature of the extrudate in the mixing zone or at least at the end of the mixing zone to, or optionally keep at, temperatures of between 5° C. and 120° C., preferably 5° C. and 80° C., more preferably between 10° C. and 45° C., even more preferably between 15° C. and 40° C.

In further embodiments of the present invention the pressure and temperature inside the extruder according to the invention, in particular at least in the calcining zone, are controlled so that in the calcining zone water is liberated from the raw material, and water and (partly) de-watered material are (at least partly) present beside each other. De-watered material may preferably be hemihydrate or anhydrite forms of calcium sulphate.

Accordingly, the extruder according to the present invention is configured to enable such pressure and temperature control by comprising pressure regulating devices (for example at least one pump and/or at least one overpressure control device), temperature setting devices (for example at least one heating device and/or at least one cooling device), and at least one control device (for example a control board or a computer).

In addition thereto, it is further preferred that the control device also allows for controlling the entire operation of the extruder, including, but not limited to controlling the screw speed, controlling the speed, by which the inlet supplies raw gypsum into the extruder, etc. Therefore, it is possible to quickly adapt the parameters within the process to varying raw gypsum input, wherein the raw gypsum quality can vary due to mining grounds or processing recycled gypsum of different qualities.

The pressure and temperature ranges for the extruder and, in particular independent from each other, for the calcining and mixing zone, are therefore, adjustable to the respective needs based on the knowledge of the person skilled in the art, process related data and/or according to control-programs (e.g. control software running on a computer controlling the extruder).

This also means that, apart from calcining materials, in particular gypsum, in order to liberate crystal water, the extruder according to the present invention can also be used or be part of processes to dry materials (similar to rotator evaporators), i.e. evaporate residues of water or other solvents from the materials. If the other solvents are flammable, the extruder should be flame- and/or explosion-proof—which in some embodiments of the present invention, is the case anyway, regardless of its employment (to dry materials and evaporate solvents).

The extruder according to the present invention may be a single screw extruder, a double or twin-screw extruder, a multi-screw extruder or a planetary roll extruder. In cases of more than one screw, the screws may be arranged parallel to each other, or they may be arranged conical. They may in variants also be arranged partly parallel and partly conical (if more than two screws are present) either entirely or partly or in any other conceivable manner. In a preferred embodiment, the extruder is a twin screw extruder. More preferably, the extruder is a twin screw extruder with sectional extruder elements, separately heatable and/or coolable and a screw design adjustable to the optimised process conditions allowing for a specific thermal dosing is used.

If the extruder has more than one screw, than the screws can be operated together or independently from one another.

Also, it is within the scope of the invention, and an embodiment thereof, that the extruder screw(s) can be segmented such that one segment of each screw is in the calcining zone and the other segment in the mixing zone, with a further segment optionally present in the outlet (zone). These segments can have the same or different inclinations with respect to the longitudinal central axis of the extruder (barrel). In variants of this embodiment, the screw-segments, however, are arranged so closely to each other, optionally with seals in between the segments (or order to avoid material to insert itself in the mechanisms of the screws), that the material transport is not interrupted by the change in inclination. For example, (twin-) screws can be prepared from several segments, preferably more than one per extruder element.

Further, in some embodiments the screws, or segments of them (also called screw elements), may be of variable inclination and the inclination can be adapted prior and/or during the extrusion process. These segments may be named due to the properties, e. g. “conveying segment”, because it is mainly conveying, or “mixing segment”, because this segment is mainly mixing. Further parameters which can be influenced by the screws are the residence time via the angle and/or the rotational speed of the screw(s), the grinding degree via grinding elements.

The speed of the screw, by which the gypsum is agitated or mixed in the extruder, is not subject to any relevant restrictions, as long as the speed is sufficient to mix the gypsum and ensure a homogeneous heat transfer from temperature setting elements to the gypsum. As a suitable screw speed, a speed in the range of from 50 to 200 turns/min and in particular from 80 to 150 turns/min can be mentioned. However, the screw speed is interconnected to the screw angle design.

As conventional extruders, the extruders according to the present invention may comprise at least one temperature setting device (e. g. a heating and/or a cooling device), at least one motor, at least one transmission system and at least one electrical control system. The way the screws are driven is not particularly limited, preferably they are driven either hydraulically or mechanically or by one or more electric motors.

In general, the heating and/or cooling of the extruder can advantageously be accomplished via electricity operated temperature setting elements, which provides the advantage that the heating and/or cooling (in contrast to current fossil fuel driven heating processes) can be driven by electricity only, and does not require the presence of oxygen. Thus, in principle, the process can also be performed in environments without an oxygen atmosphere, as in space or other planets. In such environments, the process could also be used to prepare water, which can then be used for consumption or other applications. Accordingly, in a preferred embodiment, the inventive process is performed in a vacuum atmosphere.

Similarly, several types of screw may be employed in the extruder according to the present invention such as separation type screws, shear type screws, barrier types screws, split type screws and wave type screws. It is known to the person skilled in the art, which, how many and in which order the screws may be employed.

In the context of the present invention, the specifics of the extruder-screw(s) can be selected according to the desired specifics of the product as well as the properties of the raw material.

The inventive process provides the advantage that the conversion of the calcium sulphate dihydrate to the hemihydrate and back is specifically controllable, so the energy necessary for the conversion can be minimized.

In some embodiments of the present invention single screw extruders are preferred as they generate more heat by friction and as such may reduce the heating energy required to be added in order to liberate crystal water from the raw gypsum. In one embodiment of the present invention it may also conceivable that the calcination of the raw gypsum is possible solely by the heat generated through friction.

The present invention is also directed to an apparatus or plant for manufacturing gypsum (moulded) articles, preferably gypsum panels, comprising an extruder according to the present invention as outlined herein. It is a decisive aspect of these apparatuses or plants that they do not contain—and, because of the integrated design of the extruder according to the present invention, need no—calcination device (apart from the one integrated in the extruder) for the raw gypsum. Obviously, these apparatuses or plants have, inter alia, as a decisive advantage over the prior art that they require less space and less equipment. The gypsum (moulded) articles may have any moulded/extruded form in different shapes, e. g. so-called “stucco strips” or “stucco moldings”. These “stucco moldings” or “stucco strips” can e. g. be applied to the ceiling of a room for decoration.

The present invention is further directed to a process for calcination of raw gypsum in an extruder, preferably an extruder according to the present invention as outlined herein, comprising or consisting of the following steps:
I) providing raw gypsum as a powder, a granulate or as a paste (e.g. with water);
II) feeding the raw gypsum into an extruder having a calcination zone and a mixing zone;
III) heating the gypsum in the calcination zone of the extruder, particularly to temperatures of between 5° C. and 350° C., preferably 40° C. and 280° C., more preferably between 45° C. and 200° C., even more preferably between 80° C. and 180° C., calcining the gypsum and liberating crystal water from the gypsum.

Still further, the present invention is directed to (a somewhat expanded) process, which is a process for manufacturing gypsum (moulded) articles, preferably gypsum panels using an extruder, preferably an extruder according to the present invention as described herein, comprising or consisting of the following steps:
i) providing raw gypsum as a powder, a granulate or as a paste (e.g. with water);
ii) feeding the raw gypsum into an extruder having a calcination zone and a mixing zone;
iii) heating the gypsum in the calcination zone, particularly to temperatures of between 5° C. and 350° C., preferably 40° C. and 280° C., more preferably between 45° C. and 200° C., even more preferably between 80° C. and 180° C., calcining the gypsum and liberating crystal water;
iv) feeding the calcined gypsum further into the mixing zone and there mixing it with water, preferably at least partly with water liberated in step iii), and optionally additives and/or auxiliaries;
v) optionally cooling the mixture to temperatures of between 5° C. and 120° C., preferably 5° C. and 80° C., more preferably between 10° C. and 45° C., even more preferably between 15° C. and 40° C.;
vi) feeding the mixed product to an outlet;
vii) applying the product exiting from the extruder to a shaping process.

In embodiments of these processes the outlet in step vi) may preferably a nozzle. In general, nozzles with various geometries may be used, preferred is a nozzle with a constant cross section.

In embodiments of these processes the product exiting from the extruder (also called extrudate) in the shaping process in step vii) may either be shaped by at least one nozzle (can be also called slot die), or it may be a panel (board) forming (or shaping) process as already known from the prior art.

If step v) is applied, it is preferably be applied parallel to step iv).

As in the initial stage of the process step iii) the raw gypsum has to be heated from ambient temperature to the temperature where the calcium sulphate dihydrate releases water, in one embodiment, the inventive process comprises a step of heating the raw gypsum prior to feeding into the heatable extruder at a temperature of at least 50° C. and preferably at least 80° C. Such heating may e.g. be accomplished at least in part by heat transfer from water, which is withdrawn from the extruder in the heating/calcination zones, or by heat exchange between the position in the extruder near the discharge outlet, where in turn the area of the extruder directly adjacent to the outlet may be cooled. Accordingly, in a preferred embodiment, the inventive process comprises the withdrawal of thermal energy from the calcined gypsum and/or water generated from the raw gypsum and the use of this thermal energy to heat the raw gypsum prior to the calcination in step iii).

In embodiments of these processes, the one or more extrusion screws are heated to a temperature sufficient to start calcination of the raw gypsum at the beginning of the extruder in the calcination zone and, additionally, in the mixing zone the temperature is set and preferably kept at lower temperatures than in the calcining zone.

In embodiments of the gypsum (moulded) article manufacturing process, preferably panel manufacturing process, the extrusion can be shortly (intermittently) paused in order to control the size of the product (e. g. panel/board) instead of cutting a larger sized product (e. g. board/panel) in pieces.

In embodiments of the processes of the present invention, the heating and cooling ranges can be adapted by the person skilled in the art according to his general knowledge in order to control the processes as desired or as necessary.

In embodiments of the processes of the present invention, the various temperature ranges can be adapted by the person skilled in the art according to his general knowledge in order to control the processes as desired or as necessary.

In embodiments of the processes of the present invention, the heating and/or cooling rates of the calcining and the mixing zone can be controlled to be different and can be adapted by the person skilled in the art according to his general knowledge in order to control the processes as desired or as necessary.

In embodiments of the processes of the present invention, the calcining zone is controlled to be at a higher temperature than the mixing zone.

In embodiments of the processes of the present invention, holding phases (or similar) can be performed. For example, if the exiting gypsum pulp or the produced products (e. g. panels/boards) are to be examined.

The present invention is further directed to gypsum (moulded) articles, preferably gypsum panels manufactured using an extruder, preferably an extruder according to the present invention, particularly with a process according to the present invention as outlined above.

The present invention is still further directed to the use of gypsum (moulded) articles, preferably panels prepared according to the present invention for coffered ceilings, insert ceilings, as carrier or wall panel for rooms, in particular ceilings.

The present invention is still further directed to the use an extruder, preferably one according to the present invention,
to calcine raw gypsum;
to produce settable gypsum;
to provide settable gypsum for manufacturing gypsum (moulded) articles, preferably gypsum panels and/or gypsum boards;
in the production of alpha-gypsum (a gypsum prepared under pressure in an autoclave);
in the production or manufacturing of gypsum-based construction materials;
in the production or manufacturing of gypsum blocks;
in the production or manufacturing of pre-formed construction materials based on gypsum;
in the production or manufacturing of gypsum (moulded) articles, preferably gypsum panels and/or gypsum boards;
to provide extrusion profiles, pellets, granules or tablets, in particular based on gypsum;
in the production of gypsum-based intermediate products, in particular with adaptable geometries.

It is to be noted, that generally the quality of the product, that is the gypsum exiting from the extruder is also influenced, inter alia, by the temperature at which the raw gypsum is calcined. As this is general knowledge of the person skilled in the art, the person skilled in the art will select the specific temperature based on his general knowledge.

In cases, where it is desired to reduce the overall weight of the finished gypsum (moulded) articles, preferably the finished gypsum panels, air may be incorporated as bubbles or air pockets into the aqueous gypsum slurry/gypsum pulp exiting from the device (extruder) according to the present invention resulting in gypsum (moulded) articles, preferably gypsum panels having a foamed or bubbled gypsum core having air voids (also called air bubbles).

Air bubbles may be produced either by expansion of locked (small) bubbles due to pressure difference inside and outside of the extruder or with adding foaming or air entraining agents. It is to be noted that in variants of the present invention the devices for supplying or discharging water, additives, air and the like are provided with anti-clogging equipment at their outlet/inlets (their ends) to prevent calcium sulphate (regardless of its hydration state) compounds from entering into them and clogging their paths. These can for example be simple meshes or sieves or the like, ideally these equipment pieces can be easily changed if they become clogged, for example in that they are attached by imposing on the charging or discharging device or e.g. via snap-on or screw connections.

The material of the face side and back side of the panels of the present invention is chosen from those known in the art to be suitable. In principle any material that provides support for the gypsum could be used, such as paper, non-woven fiberglass scrims, woven fiberglass mats, other synthetic fibre mats such as polyester, fleece and combinations thereof, as gypsum panel or gypsum board facer material.

For example, a fleece can be made of a polyester composite, which, in particular, can be based on a blend of glass fibres and polyester fibres (commercially available examples would be Owens Corning KB 24 and Owens Corning KB 25).

It is possible to combine two (slightly) different materials for the face side and the backside of the panel.

It is also possible to produce panels without any material on their face side and/or back side.

In another variant of the present invention, the panels of the present invention are modified. In this embodiment the panels have a structured face and/or back side cover sheet. Preferably this modification only applies to the face side of the panels. In a further continuation of this embodiment, the structured surface of the panels can be covered with a further layer of fleece, in particular the same fleece as the original cover sheet, optionally via an adhesive. The panels of the present invention can be totally encased within the fleece or the fleece can cover the face side and the back side of the panel, while the border sides are either all or some not covered. This can be due to the specific production of the panels or as desired.

The process for manufacturing gypsum panels according to the present invention is similar to the well-known continuous preparation processes for panels employing a conveyor belt or conveyor line system, with the difference being that prior to application of the gypsum pulp to the conveyor system (and cover sheet thereon) the device (extruder) according to the present invention is used.

In one more specific variant, the process for manufacturing gypsum panels according to the present invention features in step iv) mixing of the main component, i.e. the hemihydrate, with functional additives, if applicable, and then or simultaneously with mixing water, which may contain further liquid components. The thus produced gypsum-slurry (mixture) is then (with or without optional cooling in step v)) fed in step vi) to the outlet of the device (extruder) according to the present invention and then in step vii) applied to a cover sheet (face side), for example one of fleece or paper, and covered with a further cover sheet (back side), for example also one of fleece or paper. While the slurry is adjusted in its properties to a large degree or entirely in the mixing zone of the device (extruder) according to the present invention, it may, during the application step be additionally formed to the desired form and thickness. After setting of the plaster the “endless” strand can then be cut to sections of the desired dimensions (lengths). Then several of the resulting panels can be moved through a furnace/drying device together in order to evaporate excess water and thus dry the panels. After drying of the panels the panels can then be cut to the exact desired sizes, if necessary, stacked and packaged.

It should be noted, that according to the present invention, it is not necessary that in the process for manufacturing gypsum panels, conveyor belts or lines are used. It is also possible and well within the scope of the present invention to not use these. The present invention can also employ single, pre-sized (pre-cut to size) sheet, which are filled with the specified/needed amount of gypsum pulp, piece by piece. To that end, it is possible to consecutively present such pre-sized elements in form of the outlet of the device (extruder) according to the present invention or to arrange the device (extruder) according to the present invention in a moveable manner, for example rotatable (e.g. on a rotating mount) or translatable (e.g. on rails).

In some embodiments it is possible that binders are added to the gypsum. Examples of usable binders may include starch, latex and/or reconstituted paper products, which link together and create a binding system that locks all the ingredients into a structural matrix. Also, other commonly known resin binders may be added in some variants the present invention, like polyacrylics, fluoropolymers and such.

In the context of the present invention, it is possible to use raw gypsum (and water) only, without any further additives or auxiliaries.

In some preferred variants of the present invention, however, in order to improve the properties of the panels according to the present invention it is possible to add additives and auxiliaries to the gypsum during production of the panel, in particular in the mixing zone of the device (extruder) according to the present invention.

For example, the following additives or auxiliaries may be used in the context of the present invention; the invention is, however, by no means restricted to these:
liquefiers—so that less water is required;
retarder—to adjust setting times;
accelerators—to adjust setting times;
various fillers;
fibres—to reinforce the structure, e. g. cellulosic fibres, glass fibres, synthetic polymeric fibres;
air entraining agents—to provide for changes in bulk density;
foaming agents;
wet strength enhancing materials;
biocides;
preservatives;
sag resistant ingredients;
fire retarding materials;
binders;
water repellent ingredients;
dust mitigators;
starches;
as well as other ingredients or enhancing materials that are known in the art.

The fibres for example, may be selected from the group consisting of glass fibres, carbon fibres, mineral fibres in particular basalt fibres, cellulose fibres, fibres or synthetic organic polymer and mixtures thereof, particularly glass fibres.

In some instances, the gypsum may contain fillers and/or fibres in an amount of up to 150 g/m², or between 90 and 130 g/m², or between 100 and 120 g/m².

Some further examples of additives or auxiliaries that can be added during production and which, or whose residues, are then present in the gypsum of the panels according to the present invention are, in no particular order, the following:
if the gypsum exiting the device according to the present invention is to be in the form of a foam, finely ground calcium sulphate dihydrate, as an accelerator in an amount of 0.30 to 0.35% based on the resulting gypsum foam, or, optionally other accelerators,
styrene butadiene copolymers,
non-migrating starches and starch derivatives,
polyvinyl acetate,
viscosity modifiers like for example polymers based on cellulose, polyalcohol, polyurethane, polyester, polyether, polyacrylics, co-polymers thereof,
fluidizers or water-reducing agents or plasticizers, like polycarboxylate ethers,
blocking agents or calcium sequestering agents, like sodium polyacrylate/aluminium sulphate or sodium phosphonate/zinc sulphate;
one or more surfactants, which can for example be anionic, cationic, zwitterionic or non-ionic surfactants;
other additives and auxiliaries not specifically mentioned here but known in the art.

These additives or auxiliaries, as well as any other possibly added additives/auxiliaries, can be added in amounts as usual in the art or in amounts as necessary for the specific purpose and tailored to that by the person skilled in the art based on his general knowledge of the art.

In the context of the present invention any additives or auxiliaries can be added either already into the raw gypsum/raw mixture or can be added in the extruder according to the invention, preferably in the mixing zone, particularly at the beginning and/or the middle of the mixing zone.

In some instances, it is also possible to further add additives/auxiliaries to the product exiting the extruder according to the present invention (in which case a further mixing device may be provided after the extruder of the present invention).

In some variants of the present invention, the gypsum of the gypsum (moulded) articles, preferably panels according to the present invention does not contain any further additives and auxiliaries or their residues after production of the gypsum (moulded) article, preferably panel. This is intended to mean that in these variants no further additives or auxiliaries are added during production of the gypsum (moulded) articles, preferably panels; impurities present in the gypsum varieties and stemming from their respective production processes are allowed, as long as they are within the usual amounts characteristic to the respective gypsum (technical impurities accompanying the respective additives as well as residues thereof are possibly present).

It is to be understood that in the above-described processes according to the present invention further process steps, that are commonly used in the prior art for such processes, are not always described but may be done, of course, in the context of the present invention.

In one embodiment of the present invention, the gypsum (moulded) articles, preferably panels of the present invention are not subjected to a surface treatment or texturing, e. g. no embossing steps or such are performed on the gypsum (moulded) articles, preferably panels during production, in this embodiment. In another embodiment, the gypsum (moulded) articles, preferably panels of the present invention are subjected to surface treatment and/or texturing.

It is to be noted that the exact features and properties of the compounds to be employed in the processes of the present invention are not always repeated in the context of the processes, as long as they have already been described in the context of the gypsum (moulded) articles, preferably panels according to the present invention—and vice versa. Where they are not repeated, it is to be understood that those described in the context of the gypsum (moulded) articles, preferably panels according to the invention are to be employed—and vice versa. In the case of deviations, the ones described in the respective context take precedence.

Further, it is to be noted that in the present description the respectively named, described and/or employed substances, e. g. additives and the like, are not always and not necessarily described in all detail as the details and properties of commonly substances that are commonly used in the technical field the present invention addresses are usually known to the person skilled in the art sufficiently.

The gypsum (moulded) articles, preferably panels of the present invention can advantageously be installed in objects/rooms as known in the art, they are particularly suitable for application as carrier or wall panels for rooms, in particular ceilings.

The conditions for forming the respective phases of calcium sulphate are known to the person skilled in the art and can also be derived from the following table.

TABLE 1
phases in the system CaSO₄—H₂O and their properties

| | | chemical formula of the phase | | | |
|---|---|---|---|---|---|
| | | CaSO₄ *2 H₂O | CaSO₄-½ H₂O | CaSO₄ III | CaSO₄ II |
| 1 | name | calcium | calcium sulphate | anhydrite III | anhydrite II |
| | | sulphate | hemihydrate | | |
| | | dihydrate | | | |
| 2 | additional | natural gypsum, | beta-hemi | soluble | natural anhydrite, |
| | names | raw gypsum, | hydrate, beta- | anhydrite, | raw anhydrite, |
| | | technical gypsum, | gypsum, plaster of | | synthetic anhydrite, |
| | | | Paris, alpha-hemi | | |
| | | | hydrate, alpha- | | |
| | | | gypsum, | | |
| 3 | forms | | alpha-form | alpha-A III | A II-s (sparingly |
| | | | beta-form | beta-A III | soluble) |
| | | | | | A II-u (insoluble) |
| | | | | | A II-E (plaster for |
| | | | | | flooring/hard finish |
| | | | | | plaster) |
| 4 | Crystal water | 20.92 | 6.21 | 0 | 0 |
| | (M.-%) | | | | |
| 5 | density (g/cm³) | 2.31 | 2.619 beta | 2.580 | 2.93 |
| | | | 2.757 alpha | | 2.97 |
| 6 | molecular mass | 172.17 | 145.15 | 136.14 | 136.14 |
| 7 | crystal system | monocline | monocline | orthorhombic | orthorhombic amma |
| | space group | prismatic A2/a | prismatic \| 121 | C 222 | |
| 8 | Mohs hardness | 2 | | | 3½ |
| 9 | solubility in | 2.05 | 8.8 beta | 8.8 beta | 2.7 |
| | H₂O at 20° C. | | 6.7 alpha | 6.7 alpha | |
| | (g CaSO₄/I) | | | | |
| 10 | stability | <40° C. | meta stable | meta stable | 40-1180° C. |
| 11 | temperature of | | beta: 45-200° C. in | 50° C. | 200-1180° C. |
| | formation in | | beta: 45-200° C. in | vacuum | |
| | laboratory | | dry air | 100% | |
| | | | alpha: >45° C. in | humidity | |
| | | | water steam | | |
| | | | atmosphere | | |
| 12 | temperature of | | beta: 120-180° C. | beta 290° C. | 300-900° C. |
| | formation in | | dry | dry | A II-s: 300-500° C. |
| | technical | | alpha: 80-180° C. | a: 110° C. | A III-u: 300-500° C. |
| | processes | | wet | wet | A II-E: >700° C. |

The person skilled in the art is readily able to select the conditions in the respective zones of the extruder according to the present invention and/or the process according to the present invention when regarding the table.

It should be understood that the gypsum (moulded) articles, preferably panels of the present invention and the processes of the present invention are interconnected. This means that effects and facts explained with regard to the one also applies to the other as long as that makes sense and does not create contradictions.

It should further be understood that the respective features outlined above and in the claims can be combined in any suitable manner, as long as that makes sense and does not create contradictions.

Some specific advantages of the present invention can be given as follows:
The device (extruder) of the present invention has a compact structure and is comparatively small in size (compared to prior art apparatuses providing similar functionalities, which are two (or more) distinct apparatuses).
A considerable amount of water can be saved when employing the device (extruder) of the present invention.
A considerable amount of energy can be saved when employing the device (extruder) of the present invention.
The apparatuses/devices/installation engineering of the prior art relating to the calcination of gypsum can be disposed of, when employing the device (extruder) of the present invention.

It can be seen that the present invention is hugely beneficial under both economic and environmental points of view.

It should be noted, though, that the advantages given in the description are not necessarily the only advantages that can be achieved with the present invention but are some notable ones.

It is to be noted that the extruders according to the present invention are not limited to the employment in gypsum-related manufacturing processes.

The extruder according to the present invention can be employed in principle with any other extrudable materials, as long as the material and the extruder are adjusted to each other, for example in the choice of the material of the screws or a possible lining of the inside of the barrel of the extruder.

The extruder of the present invention is, therefore, particularly well suitable for other materials that liberate crystal water, preferably upon heating, for example, in some preferred embodiments, for the production of pulverulent salts or minerals with reduced crystal-water content.

### BRIEF DESCRIPTION OF THE DRAWINGS

FIG. 1 is a highly schematic representation of (an excerpt of) a gypsum panel manufacturing plant 1 with an extruder 9 according to the present invention;

FIG. 2 is a graph of test results; and

FIG. 3 is another graph of test results.

### DESCRIPTION OF THE INVENTION

In the following the invention is additionally described with reference to the figure. The figure is not true to scale and simplified. As such, features readily known to the person skilled in the art are not necessarily shown (like screws, valves, mixers, cutters, connections of the respective devices, exact configuration of known devices and such) in order to enhance the intelligibility and clarity of the figure. The invention, however, is not to be reduced to the figure, which is to be understood as being illustrative.

In the figure a grinding device/unit 2 for raw gypsum is shown. This is an optional device, and its necessity depends on the actual source and form of the raw gypsum. For example, already pulverulent raw gypsum of sufficiently small particle size does not need to be ground. The raw gypsum feed 3 (either ground or not) is fed to the inlet I of the extruder 9. While the extruder 9 is shown in the figure to be horizontally aligned, it should be noted that it is also possible to arrange the extruder 9 in an upwardly or downwardly tilted way. The gypsum is transported through the extruder from left to right via one or more extruder screws 4. The extruder screws may be arranged with temperature setting devices or may be partly or entirely directly heatable (not shown); also, they may be configured to be partly or entirely (directly) coolable (not shown). As can be seen, the extruder has two zones, one calcining zone C and one mixing zone M. In the figure, (external) temperature setting devices H are shown in the region of the calcining zone C. It should be noted, that there can also be temperature setting devices in the mixing zone M. Also further temperature setting devices (not shown) may be arranged along the entire or parts of the extruder, which may or may not be used. While not shown in the figure, the two zones may be separated from each other, for example by walls or the like. Numeral 5 denotes a feeding/charging device or unit, with which additionally water and, possibly, additives/auxiliaries can be added to the gypsum material present in the mixing zone M. It should be noted that further such devices may be present not only connected to the mixing zone M but optionally as well as to the calcining zone C and/or to the inlet I. In the calcining zone C the gypsum material is heated up to (at least) temperatures at which crystal water is liberated from the gypsum material. The liberated crystal water is preferably retained in the extruder 9 according to the invention and can then be used as seen fit, preferably (but not necessarily), as water-addition to the calcined gypsum material, in order to form settable gypsum material. Should the retained crystal water be not enough, additional water can be added (for example via feeding/charging unit 5). The extrudate is then passing the outlet O of the extruder. Then the settable extruded gypsum pulp 6 proceeds on to usual gypsum panel production steps/devices, of which here representatively only a conveyor device 8 is shown, to form gypsum panels 7.

While the extruder is depicted here in the context of gypsum processing, it should be noted, that the extruder is not limited to this gypsum material, but can be used, in principle, to process any other material that is extrudable (and in particular, if it benefits from a first calcining and then transporting zone (either with or without mixing with other substances)).

### LIST OF REFERENCE SIGNS

1 gypsum panel manufacturing plant (part of)
2 grinding device/unit for raw gypsum
3 raw gypsum feed
4 extruder screw
5 feeding/charging device
6 extruded gypsum pulp
7 gypsum board
8 conveyor device (belt, line etc.)
9 extruder
C calcining zone
M mixing zone
I extruder inlet
O extruder outlet
H (external) temperature setting device

The invention is now described in more detail with reference to the following non-limiting examples. The following exemplary, non-limiting examples are provided to further describe the embodiments presented herein. Those having ordinary skill in the art will appreciate that variations of these examples are possible within the scope of the invention.

### EXAMPLES

### Example 1

### Test Setup

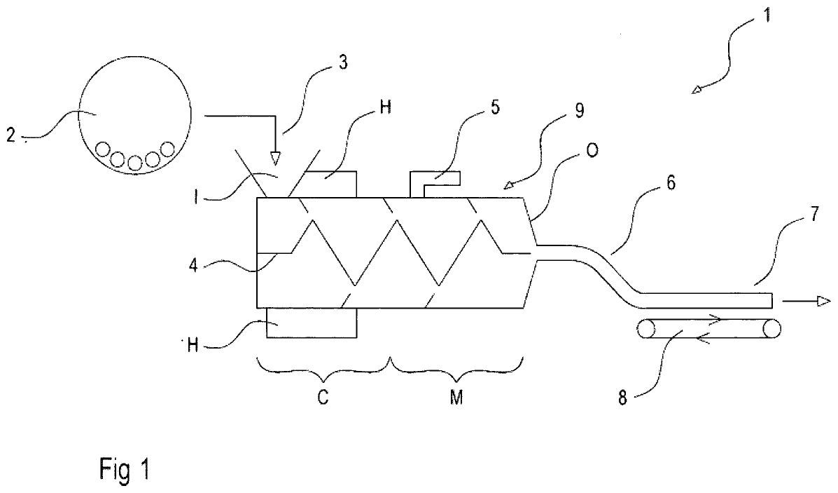

The tests were carried out with a twin-screw extruder (ZSK26 Mcc, Coperion GmbH). The twin-screw extruder used has a modular design being able to realize different lengths. Individual elements can be heated or cooled (with so-called temperature setting devices), also segments with a device for injecting water can be put together to result in an extruder according to FIG. 1 (but with two screws, also called twin-screw). Here, there calcining zone and the mixing zone (together) consist of 11 discrete elements and add up to a total length of 1100 mm, whereof the first element (element 1) was a feeding element (not temperature-controlled), where the raw gypsum was fed into the extruder. The particle size of the raw gypsum was about 1 mm, which contained <90% calcium sulphate dihydrate and residual amounts of calcite and dolomite. The gypsum did not contain hemihydrate or anhydrite. The elements 2 to 10 were temperature-controlled to the desired temperature range for the tests (see table 2) and at the 10th element water injection was performed. However, water injection is preferably performed when the temperature in the extruder is below 100° C., in this case 98° C.

Also, the twin-screws within (the 11 elements of) the extruder were prepared from segments, here 33 screw segments, mostly conveying segments. The exception was the area where the water was injected; here, to have better mixing than with the conveying segments, two special segments were installed (mixing segments). The deionized water was added with the aid of an HPLC pump type P 4.1S from Knauer Wissenschaftliche Geräte GmbH. For the injection of deionized water (30 wt.-% relative to the raw gypsum input), a configuration with nozzle was used. However, the water evaporated in the calcination process could have been injected here, also.

In this setup, the first 4 elements of the extruder were used for heating, after which the extruder is cooled down to just below 100° C. in order to avoid sudden evaporation of the injected water. The elements were set to the temperatures shown in table 2. The element numbers start with 1 reflecting the first element of the Extruder at the inlet (I).

TABLE 2
temperatures in the single temperature-controlled elements
of the extruder- while performing the calcination/extrusion

| Element number | 1 | 2 | 3 | 4 | 5 | 6 | 7 | 8 | 9 | 10 | 11 |
|---|---|---|---|---|---|---|---|---|---|---|---|
| Temperature (° C.) | — | 250 | 260 | 300 | 300 | 250 | 180 | 150 | 130 | 98 | 98 |

For dosing the gypsum via the inlet into the extruder DDSR20 dosing from Brabender GmbH & Co. KG KG was used. Dried gypsum, ground to 1 mm, was used as the starting material. The dried gypsum consisted of >90% gypsum (dihydrate), with calcite and dolomite as minor components. Anhydrite and bassanite (hemihydrate) were not included. The dosage was 2 kg/h and the rotation was 50 turns/min.

It was possible to extrude a moulded strand, which was still flexible to some extent, according to the selected slot die. XRD analyses of the extruded strand showed that it (again) consisted mainly of gypsum (dihydrate, 86.97%), i.e. hydration of the bassanite (hemihydrate) occurred. Only 4.33% of bassanite were found in the XRD analysis and no anhydrite.

However, comparison tests without using water injection resulted mainly in bassanite (hemihydrate, 83.38%), with small amounts of gypsum (dihydrate, 7.89%) and anhydrite (0.23%) as shown by XRD analyses.

### Example 2

For optimization further tests solely for calcination, which basically means to produce bassanite, were performed. Here the extruder was used as described above but without water injection and without slot die.

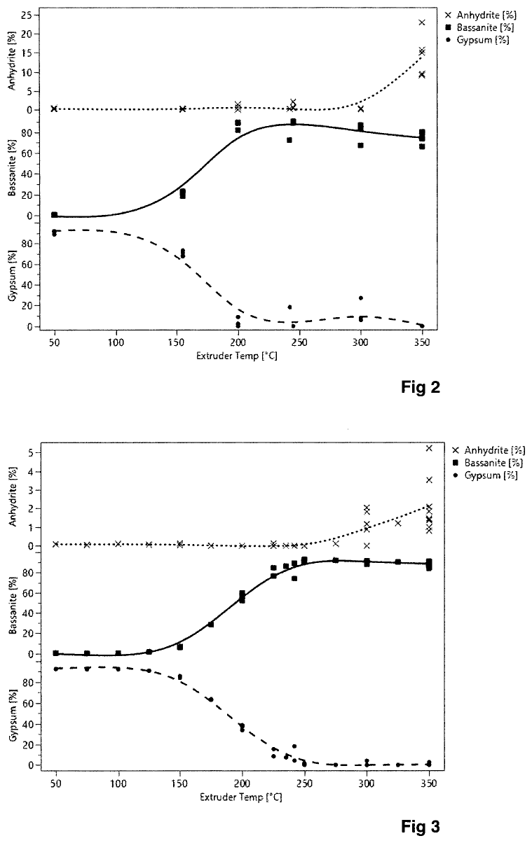

The calcination in the extruder was performed with varying extruder temperature of 50° C. to 350° C. The results of these test are shown in FIG. 2. As can be seen therein at 150° C. about 20% of the hemihydrate was detected and at about 200° C. 80 to 90% of the hemihydrate were found. At 350° C. significant quantities of anhydrite (10 to 20%) had formed.

Further tests for calcination were performed with the extruder as described above in example 2, but shorter. Here, there calcining zone and the mixing zone (together) consisted of 5 discrete elements and add up to a total length of 500 mm. The calcination in the extruder was performed with varying extruder temperature of 50° C. to 350° C. The results of these test are shown in FIG. 3. As can be seen therein, calcium sulphate hemihydrate starts to form at a temperature of about 150° C. and at 175° C. there is conversion to the hemihydrate to about 25%. At temperature of about 225° C. about 80 to 90% hemihydrate is obtained and above a temperature about 300° C. minor quantities of the anhydrite are formed.

Comparison of the longer versus the shorter extruder show that with the longer extruder, it is apparent that the profile of calcium sulphate dihydrate to hemihydrate to anhydrite is slightly shifted to lower temperatures in comparison to the results with the shorter extruder. Also, the significant quantities of anhydrite at 350° C. in the longer extruder are attributable to a longer exposition of the gypsum to higher temperatures as the result of the longer extruder design.

### Example 3

For the longer extruder design of example 2 the residence times of the raw gypsum in the extruder were calculated for different screw speeds and different feeding rates of the gypsum. The results of this calculation are shown in the below table 3.

TABLE 3

Feeding rate

| Residence time | | 2 kg/h | 3 kg/h | 4 kg/h | 6 kg/h |
|---|---|---|---|---|---|
| Screw | 200/min | 29 s | 24 s | 22 s | 19 s |
| speed | 150/min | 35 s | 28 s | 26 s | 23 s |
| | 100/min | 42 s | 37 s | 32 s | 30 s |
| | 50/min | 60 s | 57 s | 54 s | 52 s |

As can be seen from Table 3, the residence time gets shorter by rotating faster. Further, the more gypsum is fed at constant speed, the shorter is residence time, which is surprising.

1. An extruder, preferably for calcining and extruding raw gypsum, comprising at least the following elements:
A) inlet, preferably for raw gypsum, in particular already ground raw gypsum, optionally including a grinding unit for raw gypsum;
B) extruding zone comprising at least one extruder screw and comprising
B1) a calcination zone;
B2) a mixing zone, optionally integral with the downstream end of the calcination zone;
the extruding zone comprising at least one temperature setting device selected from
a) at least one entirely or partly temperature settable extruder screw, and/or
b) one or more temperature setting devices each setting at least a part of the extruder barrel;
c) optionally, other internal or external temperature setting devices;
C) outlet zone or device, in particular an orifice,
wherein the extruder is preferably configured to capture and/or retain water liberated in the calcination zone and optionally to deliver this water into the mixing zone.

2. The extruder according to claim 1, wherein it comprises at least one of the following additional devices:
at least one device for supplying water or aqueous mixtures into the mixing zone,
at least one device for discharging water or aqueous mixtures from the mixing zone,
at least one device for supplying solid additives into the mixing zone
at least one device for supplying water or aqueous mixtures into the inlet A), which can be of any kind known in the art, in particular a simple inlet port like a nozzle,
at least one device for supplying solid additives into the inlet A), which can be of any kind known in the art, in particular a simple inlet port like a nozzle.

3. The extruder according to claim 1, wherein it has different pressure zones and
optionally comprises a device for increasing or decreasing the pressure inside the extruder, and/or
further optionally comprises an overpressure-releasing device, in particular an overpressure-valve.

4. The extruder according to claim 1, wherein the temperature setting devices are each independently configured to heat the extrudate depending on its position in the extruder to, and optionally keep, at temperatures of between 5° C. and 350° C., preferably 5° C. and 280° C., more preferably between 10° C. and 200° C., even more preferably between 15° C. and 180° C.;
in particular
to set the temperature of the extrudate in the calcination zone to, and optionally keep at, temperatures of between 5° C. and 350° C., preferably 40° C. and 280° C., more preferably between 45° C. and 200° C., even more preferably between 80° C. and 180° C., and
to set the temperature of the extrudate in the mixing zone or at least at the end of the mixing zone to, or optionally keep at, temperatures of between 5° C. and 120° C., preferably 5° C. and 80° C., more preferably between 10° C. and 45° C., even more preferably between 15° C. and 40° C.

5. An apparatus or plant for manufacturing gypsum (moulded) articles, preferably gypsum panels, comprising
an extruder according to claim 1,
wherein the apparatus does not comprise a calcination device for the raw gypsum other than the extruder.

6. A process for calcination of raw gypsum in an extruder, preferably an extruder according to claim 1, comprising or consisting of the following steps:
I) providing raw gypsum as a powder, a granulate or as a paste;
II) feeding the raw gypsum into an extruder having a calcination zone and a mixing zone;
III) heating the gypsum in the calcination zone of the extruder, particularly to temperatures of between 5° C. and 350° C., preferably 40° C. and 280° C., preferably between 45° C. and 200° C., more preferably between 80° C. and 180° C., calcining the gypsum and liberating crystal water from the gypsum.

7. A process for manufacturing gypsum (moulded) articles, preferably gypsum panels using an extruder, preferably an extruder according to claim 1, comprising or consisting of the following steps:
i) providing raw gypsum as a powder, a granulate or as a paste;
ii) feeding the raw gypsum into an extruder having a calcination zone and a mixing zone;
iii) heating the gypsum in the calcination zone, particularly to temperatures of between 5° C. and 350° C., preferably 40° C. and 280° C., more preferably between 45° C. and 200° C., even more preferably between 80° C. and 180° C., calcining the gypsum and liberating crystal water;
iv) feeding the calcined gypsum further into the mixing zone and there mixing it with water, in particular at least partly the water liberated in step iii), and optionally additives;
v) optionally cooling the mixture to temperatures of between 5° C. and 120° C., preferably 5° C. and 80° C., more preferably between 10° C. and 45° C., even more preferably between 15° C. and 40° C.;
vi) feeding the mixed product to an outlet;
vii) applying the product exiting from the extruder to a shaping process.

8. A Gypsum (moulded) article, produced by a process according to claim 7.

9. The article of claim 8, wherein said article comprises a ceiling panel.

10. (canceled)
